(19) United States
(12) Patent Application Publication
(10) Pub. No.: US 2026/0332020 A1
(43) Pub. Date: Oct. 22, 2026

(54) High-Efficiency Electromagnetic Transducer

(71) Applicant: Nolan Francis Chowansky, Bluffton, SC (US)

(72) Inventor: Nolan Francis Chowansky, Bluffton, SC (US)

(21) Appl. No.: 19/182,532

(22) Filed: Apr. 17, 2025

(51) Int. Cl. H02K 53/00; H02K 21/28

(52) U.S. Cl. CPC H02K 53/00; H02K 21/28

(57) ABSTRACT

A High-Efficiency Electromagnetic Transducer system comprises a transducer assembly and an electrically conductive energy-storing housing. The transducer assembly is supported by magnetic elements and is configured for electromagnetic induction. Energy transfer rods and directional diodes provide electrical energy transfer between the transducer assembly and the energy-storing housing. The system includes input and output ports for connection to external electrical power sources, electrical loads, and other transducer systems.

### BACKGROUND OF THE INVENTION

### Field of the Invention

The present invention relates generally to energy generating and storage systems, and more particularly to a modular, self-sustaining transducer system that employs a magnetic electric transducer mechanism to continuously produce, recirculate, and output energy. The invention integrates magnetic levitation, electromagnetic induction, and advanced materials to support long-duration energy generation and storage. It is particularly well suited for high-demand applications including, electronic devices, aerospace systems (planes, jets, spacecraft, satellites, electric vertical takeoff and landing (EVTOL) aircraft, and drones), maritime vessels (ships, boats, submarines, and small watercraft), and stationary transducers in remote or off-grid environments, where operational longevity, reliability, and serviceability are critical.

### Description of Related Art

Conventional energy storage systems, including battery-based technologies, often rely on chemical reactions for power generation and storage. These systems are typically limited in operational lifespan, suffer from thermal inefficiency, and are frequently non-serviceable once internal chemical capacity is exhausted. Additionally, such systems usually lack integrated energy feedback mechanisms to support real-time recirculation or conservation during active power draw. Chemical batteries require frequent recharging; fossil fuel systems depend on refueling infrastructure, and both often rely on rare-earth minerals like lithium and neodymium, contributing to weight penalties, environmental challenges, and waste due to non-serviceable designs, unlike the present invention's lightweight, sustainable, and serviceable system.

Prior attempts to enhance energy efficiency through mechanical or electromagnetic methods have not provided a fully integrated, modular solution like the present invention. For instance, magnetic levitation generators such as WO2016019221A1, CN102820834A, and CN202309471U utilize levitated components to generate electricity but lack vacuum-sealed environments, graphene-based energy-storing housings, or closed-loop recirculation. CN201821303U describes a vacuum-capable wind turbine generator but is application-specific and omits graphene or modular connectivity. Graphene is used in CN202034833U, CN105405960A, U.S. Pat. No. 10,938,032B1, US20140030590A1, and US20180197690A1 for coils or electrodes, not as a structural housing that doubles as energy storage. Flywheel systems like CN103475087A, U.S. Pat. No. 5,614,777A, CN102570749A, WO2011075223A1, and U.S. Pat. No. 6,160,336 employ vacuum and levitation but lack graphene storage or modular energy transfer. CN103161740A, US20130147296A1, and WO2020126040A1 focus on non-energy applications like pumps or transport, while US20130113294A1 and U.S. Pat. No. 8,350,411B2 address modular storage without the transducer setup. Micro-scale generators, such as US20160020694A1 and US20130234481A1, for portable devices omit magnetic levitation, vacuum sealed internal components, or graphene. Unlike these systems, the present invention integrates a magnetically levitated transducer, vacuum-sealed graphene housing with energy storage, efficient closed-loop electrical recirculation, and modular scalability across diverse applications, offering a potentially non-obvious advancement.

### SUMMARY OF THE INVENTION

The present invention, referred to as the High-Efficiency Electromagnetic Transducer, comprises a transducer assembly pre-charged with application-appropriate electrical energy. The transducer is surrounded by permanent magnets arranged to generate a rotational magnetic field, enabling electromagnetic energy generation and recirculation through induction. In the primary configuration, the transducer is supported by magnetic levitation mechanisms, creating a near-frictionless environment, with energy transfer facilitated by wireless inductive means. In alternative configurations, conductive energy transfer rods serve as fixed rotational supports for the transducer, with magnetic ball bearings in a housings attached to each end of the transducer to enable low-friction rotation, while fixed mounts attached to the bottom of the transducer housing ensure structural stability. This modular design offers versatility, accommodating both magnetically levitated and mechanically supported transducer setups.

An electroconductive, lightweight, and heat-resistant structural screen or cage encloses the transducer. This structure is composed of materials such as graphene, carbon nanotubes, tungsten, rhenium, or similar conductive elements, optionally coated with silicon carbide. The screen secures magnetic elements used for levitation and ensures thermal durability, enabling continued operation under extreme temperatures while supporting magnetic flux and energy recirculation. The system minimizes rare-earth materials, using neodymium solely for permanent magnets constituting less than 5% of system mass, with graphene or similar materials providing structural and energy storage functions.

The system includes a removable, serviceable housing composed of conductive, energy-storing materials such as graphene or similar metals. The housing is vacuum-sealed to reduce friction and support long-term energy efficiency. It functions both as a physical enclosure and as an energy storage medium, facilitating unidirectional energy exchange with the transducer via energy transfer rods. The housing is configured as a six-sided modular unit, featuring input and output adapters on each side to enable series or parallel connections with other transducers. External power attachment ports allow for integration with conventional energy sources and renewable systems including solar panels, hydroelectric generators, and Permanent Magnet Synchronous Generators (PMSGs). The system supports standard household alternating current (AC) input/output interfaces at nominal voltages from 100 V to 240 V inclusive (50/60 Hz), ensuring compatibility with substantially all global residential and commercial low-voltage electric power systems. An on and off button is incorporated into an LCD Screen for safety during service or system anomalies.

The transducer assembly is seated within a pre-molded, nonconductive buffer composed of synthetic silicon oxycarbide (SiOC) foam, boron nitride (BN) foam, or equivalent materials. These buffers are heat-resistant (rated for ≥2,500 °), low-energy absorbing, and permeable for airflow, contributing to electromagnetic isolation and thermal regulation. The entire assembly is enclosed in a rugged outer shell constructed from high-strength, heat-resistant composite materials, such as but not limited to GraphInsul-Moly, GraphInsul-TaC, or comparable advanced ceramics or refractory composites.

An optional system enhancement includes a distributed fan propulsion mechanism coupled with a Permanent Magnet Synchronous Generator (PMSG). This configuration introduces active cooling and thermal management through a series of strategically placed internal fans. The fans redirect kinetic energy toward the PMSG, converting it into electrical energy and feeding it back to the transducer. This process supports continuous energy regeneration and temperature regulation. The fan-integrated configuration is particularly suited for long-duration use in electric vehicles, maritime vessels, drones, electric vertical takeoff and landing (EVTOL) aircraft, and spacecraft, where energy efficiency and autonomy are critical. This design supports continuous operation for over ten years, with the potential for lifecycle extension through external electricity input and renewable energy integration.

The invention is adaptable for use across multiple industries, from at-home standalone electrical power sources to aerospace applications, the system offers lightweight and resilient energy delivery, resistant to fluctuating electromagnetic conditions. The system is scalable from micro-scale applications, generating 1-10 W (but not limited to), for portable devices such as phone or laptop chargers, to medium-scale uses, delivering 1-10 kW (but not limited to) for electric power tools, to large-scale applications, producing 50 kW-1 MW (but not limited to) or more for electric vehicles, maritime vessels, and space stations. The system is lighter than equivalent chemical battery packs or fossil fuel tanks, with embodiments ranging from 100 g for micro units to 500 kg (but not limited to) or more for large-scale units, compared to 400-600 kg for electric vehicle batteries or fuel systems of similar capacity.

For aviation and satellite systems, the transducer could power electric jet propulsion, or as an additional power source to hybrid fixed wing and rotary wing aircraft, unmanned ariel vehicles (UAVs) and electric vertical takeoff and landing vehicles (EVTOLs) aircraft, improving flight duration and reliability. In remote or space-based deployments, the device may function as a standalone power source capable of more than ten years of continuous operation. Integration with renewable sources can extend this operational lifespan beyond twenty years in static or low-activity environments such as satellites or remote installations.

Optional features include an external charging interface for supplemental power during maintenance or emergencies, as well as a PMSG-based power booster to further extend the operational lifespan.

Accordingly, the High-Efficiency Electromagnetic Transducer offers a modular, scalable, and multifunctional system for power generation, storage, and distribution in terrestrial and extraterrestrial applications. The system serves as a direct replacement for chemical batteries and fossil fuel systems, delivering equivalent or superior power without external recharging or refueling across portable, vehicular, and industrial applications for at least 10 years. An initial charge enables continuous operation for at least 10 years without recharging, delivering energy from watts to megawatts depending on system scale.

The system is designed for modularity and inter-unit energy transfer, enabling one transducer unit to charge another via input and output ports. Components are individually serviceable, allowing replacement without full system disassembly.

Collectively, these features provide a durable, zero-input energy system capable of sustained operation under load across a range of extreme conditions, with minimal maintenance and prolonged service life.

### BRIEF DESCRIPTION OF THE DRAWINGS

FIG. 1 is a perspective view of the ruggedized housing of the High-Efficiency Electromagnetic Transducer, illustrating the exterior design including input and output ports, an LCD screen for displaying technical information, ventilation ports with covers, and integrated handles with a lid enclosure.

FIG. 2 is a cross-sectional view of the High-Efficiency Electromagnetic Transducer, showing the internal arrangement of the ruggedized outer housing, foam buffer layer, and the internal transducer assembly.

FIG. 3 is a block diagram illustrating the energy loop system architecture of the High-Efficiency Electromagnetic Transducer.

### DETAILED DESCRIPTION OF THE INVENTION

The High-Efficiency Electromagnetic Transducer system is designed for sustained energy production and recirculation, integrating a modular, serviceable housing with advanced internal components. The system achieves long-duration, efficient power generation through a combination of a nanocrystalline core transducer or similar electromatic conducive core, magnetic levitation, and a graphene-based (or similar energy storing material) energy storage housing. It supports scalability, environmental durability, and compatibility with standard power grids, and renewable energy sources, making it suitable for terrestrial, maritime, aerial, and extraterrestrial applications.

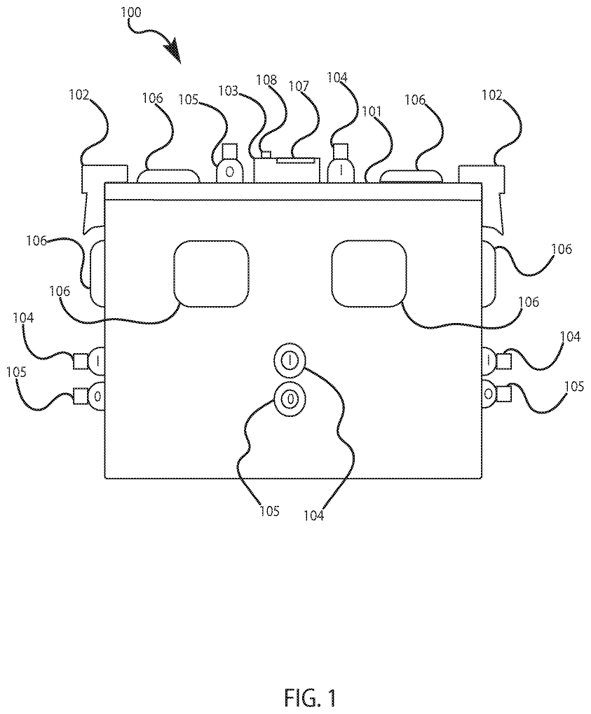

FIG. 1: Ruggedized housing system (100), designed for harsh operational environments. The housing features a removable lid (101) secured by dual-function carrying handles (102) that also serve as locking mechanisms for transport and operation. An LCD screen (103) on the upper surface displays real-time diagnostics, including energy levels, power output, and operational status, and includes an integrated on/off switch for system control. Input (104) and output (105) connectors, mounted externally through a threaded base and secured by tungsten screws, enable integration with external power sources and loads. Vent covers (106) with male adapters support passive or active cooling, removable in controlled environments for enhanced heat dissipation. The housing's modular design supports component-level servicing, scalability, and compatability with auxiliary systems like external cooling or renewable energy inputs.

Housing Lid and Locking Mechanism. The removable lid (101) provides access to internal components for maintenance, inspection, and component replacement. It interfaces with the main housing body through a locking mechanism integrated into the carrying handles (102), ensuring secure closure during operation and quick detachment for servicing.

Input connectors (104) receive external power for initial charging, maintenance, or lifecycle extension via renewable sources, while output terminals (105) deliver electrical power to external systems. Both connectors are screw-mounted externally, allowing complete disassembly without compromising internal components. They support High Voltage Interlock Loop (HVIL) connections for safe and stable electrical integration.

Ventilation and Thermal Management: vents (211), facilitate passive or active thermal management, with threaded male adapters for attaching forced cooling components like fans or heat exchangers. In weather-free environments, these covers can be removed to maximize passive heat dissipation, enhancing system performance in high-performance settings.

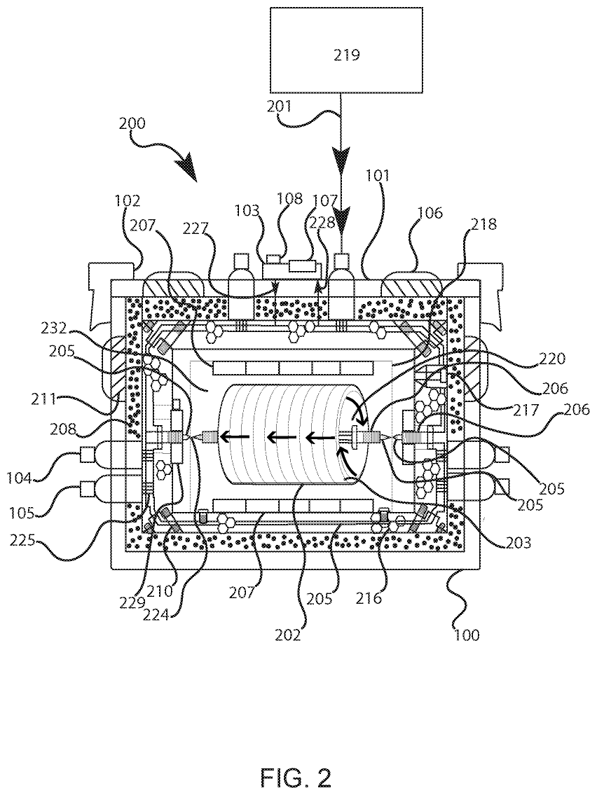

FIG. 2 provides a cross-sectional view of the internal components responsible for energy production, storage, and recirculation. The core component is the transducer (202), formed from a nanocrystalline alloy or similar material core wrapped with a high-conductivity silver coil and encased in an aluminum nitride (AIN) sheath (or similar material) (203). This sheath enhances electromagnetic conductivity, provides protection to the transducer, and ensures structural stability. The transducer is initially charged via an external power source (200) connected through a primary power wire (201), requiring no recharging for 10 years after an initial charge (e.g., 1 MWh for a 100 kW unit, producing up to 8.76 GWh).

Magnetic Levitation and Alternative Support. In magnetic levitation configurations, the transducer (202) is suspended in a vacuum-sealed chamber using high-powered magnetic elements (207), creating a near-frictionless environment to maximize energy transfer and minimize wear. Alternatively, magnetic ball bearings at the ends of energy transfer rods (205) support controlled rotational motion in axle-based embodiments, offering design flexibility.

Energy Transfer Rods and Diodes. The transducer (202) connects to energy transfer rods (205) with integrated directional diodes (206) to ensure unidirectional energy flow. These rods wirelessly transmit electromagnetic energy to a central rod, which interfaces with four lateral rods along the inner frame, routing electricity to the energy-storing housing (216).

The Energy-Storing Housing. The modular energy-storing housing (216), constructed from graphene or similar conductive material, receives, stores, and redirects energy through another set of internal rods (205) on the opposite side. Energy is wirelessly transmitted back to the transducer via a final series of diodes (206) and rods, completing a self-sustaining cycle. The housing is assembled with interlocking joints and secured by high-strength tungsten (or similar metal) screws (210) for serviceability and upgrades.

Housing Structure and Thermal Buffering. The housing comprises a layered assembly: a high-temperature boron nitride (BN) foam (or similar high temperature foam) buffer (208) for thermal insulation and mechanical protection, a rigid energy barrier layer as the inner shell, and a composite, impact-resistant outer shell (209). Vents (211) with threaded covers (212) allow natural or forced ventilation, removable for passive cooling or replaceable with active cooling devices.

Vacuum Sealing Valve. A singular, spring-free, all-metal angle valve (217) ensures a vacuum-sealed environment (<10⁻¹² mbar·L/s). Featuring a single-crystal tungsten knife-edge sealing against a high-conductivity gasket, such as a silver-plated, single-crystal OFHC copper component or a functionally equivalent metal-sealed design, the valve is bakeable (450 °open, 350 °C closed) and uses ESR 316LN stainless steel for low outgassing. A 316 L stainless steel bellows and sapphire-tipped, tungsten-coated poppet enable particle-free actuation via samarium-cobalt magnets, with CF flanges for easy connection to the graphene housing.

LCD Screen and Safety Mechanism. An LCD screen (214) mounted at the housing's upper section displays system status, energy levels, and diagnostics, with an integrated on/off switch. Connected via wires to internal switches that interfaces with energy transfer rods (205). The LCD screen detaches when the lid (101) is removed, automatically powering down the system for safety during maintenance.

Handles and lever locks (215) secure the removable lid and provide grip points for transportation. Input (204) and output (213) connectors, secured by tungsten fasteners, extend through the graphene housing to connect directly to the internal energy storage medium, ensuring reliable electrical integration.

Electroconductive Cage. The transducer (202) is housed within an electroconductive structural cage (218), made of graphene, carbon nanotubes, tungsten, or rhenium, optionally coated with silicon carbide. This cage holds magnetic elements, withstands extreme temperatures, and supports magnetic flux generation, with rare-earth materials (e.g., neodymium) constituting less than 5% of system mass.

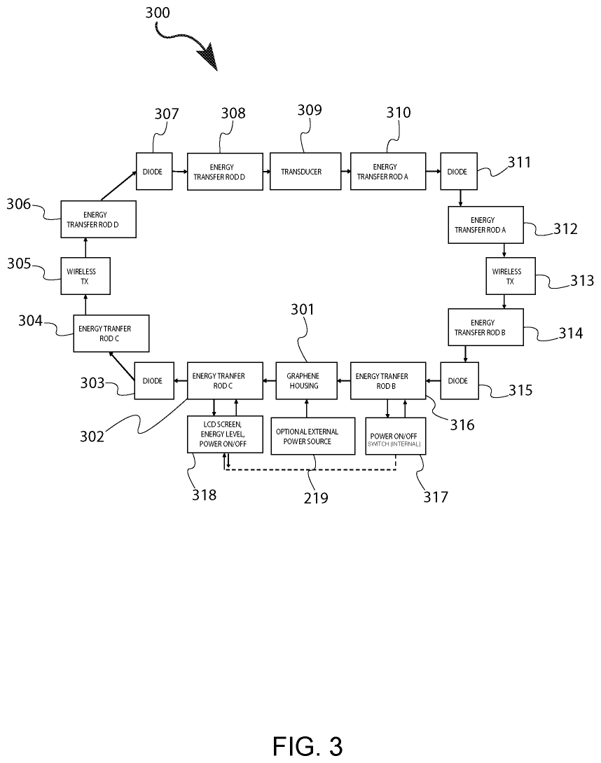

FIG. 3 Illustrates the closed-loop energy transfer system. An external power source (300) provides initial or supplementary charging to the graphene energy-storing housing (301). Energy flows through energy transfer rod C (302), a diode (303), and rod C (304), then wirelessly transmits (305) to rod D (306). A diode (307) directs energy to rod D (308), which feeds the transducer (309). Energy continues through rod A (310), a diode (311), and rod A (312), wirelessly transmitting (313) to rod B (314). A diode (315) directs energy to rod B (316), returning it to the housing (301), completing the cycle.

LCD Screen and System Switching. An LCD screen (318) connected to rod C (302) displays power levels and includes an on/off switch, electronically linked to an internal switch (317) for synchronized system control. This ensures user interaction via the LCD screen operates both internal and external switching functions.

Modular Scalability and Interconnectivity. The housing includes male/female interlocking adapters for connecting units in series or parallel via input/output ports (204, 213), enabling scalability and energy redundancy. Standard input/output ports (204, 213) support household alternating currents (AC) systems, including but not limited to voltages ranging from 100V and 240V systems, with modular renewable input connectors for solar, hydroelectric, or wind energy via Permanent Magnet Synchronous Generators (PMSGs).

An optional distributed fan propulsion system converts kinetic energy via PMSGs, routing it back to the transducer (202) through the input port (204). For mechanical platforms, regenerative braking recovers kinetic energy during deceleration, connected to the input port (204) to the transducer, enhancing efficiency. Induced air can actively cool the system through the ventilation ports (106, 211).

Optional components include an external charging plug for supplemental input and a PMSG-based turbocharging unit for high-demand cycles, boosting energy throughput.

The transducer serves as a primary power unit for standalone electrical power, electric vehicles, maritime vessels, aerospace platforms, UAVs, EVTOL aircraft, remote field stations, and satellites.

This energy solution, powered by advanced graphene-based storage and transduction technology, offers unmatched scalability to meet the demands of any application, from compact personal devices to vast extraterrestrial infrastructure. Its modular design allows the system to be tailored to deliver precisely the right amount of power and energy storage, adapting seamlessly to the needs of each use case. At its smallest, the system can be crafted into a lightweight, portable unit, small enough to fit in a pocket, providing ample power for charging smartphones, wearables, or other personal electronics. As needs grow, the system scales effortlessly into mid-sized configurations, capable of energizing households, electric vehicles, or off-grid setups with reliable, sustained power. For larger demands, the technology expands into robust units that drive industrial facilities, data centers, or critical subsystems for space stations, delivering substantial energy over extended periods. At its most ambitious, the system can be configured into expansive arrays, powering entire communities, planetary outposts, or deep-space missions with vast, long-term energy reserves. By adjusting the unit's size, weight, and internal architecture, the system achieves the desired balance of power output and storage capacity, from fleeting bursts for small gadgets to decades-long energy provision for interstellar endeavors.

The graphene-based design ensures exceptional efficiency and durability, maintaining high performance across all scales. Compared to traditional alternatives like lithium-ion batteries or diesel systems, this solution is significantly lighter and more compact, enhancing portability for terrestrial applications and reducing launch costs for space-bound missions. Its flexibility eliminates the need for bespoke designs, as the same core technology can be customized to suit any specification, whether for a single handheld device or a network of interconnected units powering a lunar base.

The High-Efficiency Electromagnetic Transducer system integrates a nanocrystalline core transducer, magnetic levitation, and a graphene-based energy storage housing to achieve a closed-loop efficiency of 99.9%. Housed in a ruggedized, modular enclosure, the system supports wireless energy transmission, regenerative cooling, and renewable energy inputs, eliminating reliance on frequent recharging or refueling. Scalable from portable electronics to heavy maritime and space applications, it delivers continuous power for over 10 years, with embodiments producing over 8.76 GWh and supporting autonomous operation in diverse environments, revolutionizing energy solutions across industries.

### CONCLUSION

The High-Efficiency Electromagnetic Transducer system offers a modular, scalable, and durable solution for sustainable energy generation, storage, and transfer across a wide range of operational environments. By incorporating magnetic levitation, electromagnetic induction, and advanced conductive materials such as graphene, carbon nanotubes, tungsten, and rhenium, the system delivers efficient and autonomous energy output in a compact form factor.

The architecture of the system includes a pre-charged magnetic electric assembly, a vacuum-sealed six-sided housing, and integrated energy transfer rods, enabling near-frictionless operation and optimal thermal regulation. The housing supports modular expansion via input and output ports, allowing units to be connected in series or parallel to form continuous energy loops. Standardized input/output ports support both conventional power grids and renewable energy sources, while interfaces for regenerative braking and optional subsystems further enhance energy cycling capabilities.

Connecting optional components such as distributed fan propulsion and Permanent Magnet Synchronous Generator (PMSG) modules support internal energy regeneration, enabling the transformation of kinetic and thermal energy into usable electrical power. These features contribute to extended operational lifespans, reduced reliance on external charging, and sustained energy autonomy.

The system is suitable for deployment as a standalone electrical power source, electric vehicles, maritime vessels, unmanned aerial vehicles (UAVs), electric vertical takeoff and landing (EVTOL) aircraft, satellites, and other aerospace platforms. Its low-maintenance, serviceable housing and integration flexibility make it especially well-suited for long-duration missions and remote or off-grid installations, with the potential to operate continuously for over ten years—and up to twenty years or more when integrated with renewable inputs.

The transducer system also enables inter-unit energy transfer, allowing one transducer to recharge another through a dedicated interface. This capability enhances redundancy and system resilience in multi-unit configurations and supports continuous closed-loop energy operation.

Overall, the High-Efficiency Electromagnetic Transducer provides a highly adaptable and efficient energy solution for modern power systems. Through its integration of advanced materials, magnetic levitation, wireless energy transfer, and regenerative feedback mechanisms, it enables extended autonomous operation with minimal environmental impact, offering a technologically robust alternative to conventional energy platforms.

1. An electromagnetic energy transducer system comprising:
(a) an electrically conductive energy-storing housing configured to receive, store, transfer, and deliver electrical energy;
(b) a magnetic electric transducer positioned within the housing and configured generate electrical energy through electromagnetic induction, the transducer comprising:
(i) a core comprising a nanocrystalline alloy or similar material; and
(ii) an electrically conductive winding comprising silver or another high-conductivity material disposed about the core;
(c) a plurality of permanent magnetic elements positioned around the transducer and supported by an electrically conductive structural cage, the magnetic elements being configured to magnetically support the transducer and provide a magnetic field for electromagnetic induction;
(d) a vacuum-sealed chamber disposed-within the housing:
(e) a magnetic levitation assembly comprising the magnetic elements and configured to support the transducer within the vacuum-sealed chamber to reduce mechanical friction during rotation;
(f) a plurality of electrically conductive energy transfer rods electrically coupled to the transducer and configured to provide an electrical energy transfer pathway between the transducer and the energy-storing housing; and
(g) a plurality of directional diodes electrically coupled to the energy transfer rods and configured to provide unidirectional electrical energy flow through the electrical energy transfer pathway between the transducer and the energy-storing housing; and
(h) at least one external electrical input connector configured to receive electrical energy from an external power source for initial charging of the system,
wherein rotation of the transducer relative to the magnetic field provided by the permanent magnetic elements generates electrical energy by electromagnetic induction in the electrically conductive winding, and the energy transfer rods and directional diodes provide an electrical energy transfer pathway between the transducer and the energy-storing housing.

2. (canceled)

3. (canceled)

4. (canceled)

5. (canceled)

6. (canceled)

7. The system of claim 1, further comprising one or more external power output connectors configured to deliver electrical energy to an external electrical device or electrical load.

8. The system of claim 1, further comprising output and input adapters on at least one side of the housing for modular connection of multiple transducer units.

9. The system of claim 1, wherein the external electrical input connector is further configured to receive electrical energy from the external power source for supplemental charging of the system.

10. The system of claim 1, further comprising an LCD screen configured to display system status, energy levels, and diagnostic information, and an on/off switch configured to activate or deactivate the system.

11. (canceled)

12. The system of claim 1, further comprising one or more removable ventilation covers associated with ventilation openings in the housing and configured to permit passive or active airflow through the housing.

13. (canceled)

14. (canceled)

15. The system of claim 1, wherein the housing comprises interlocking modular sections configured to be secured together by one or more screws.

16. (canceled)

17. (canceled)

18. (canceled)

19. The system of claim 1, wherein the magnetic elements comprise permanent magnets.

20. (canceled)

21. (canceled)

22. (canceled)

23. (canceled)
